(19) United States
(12) Patent Application Publication
(10) Pub. No.: US 2002/0003343 A1
(43) Pub. Date: Jan. 10, 2002

(54) DASHBOARD

(76) Inventor: UDO KANSTEINER, WITTEN (DE)

Correspondence Address: KATHRYN A MARRA, DELPHI TECHNOLOGIES INC, LEGAL STAFF, P O BOX 5052 MAIL CODE 480-414-420, TROY, MI, 480075052

(21) Appl. No.: 09/345,926

(22) Filed: Jul. 1, 1999

(51) Int. Cl. B62D 25/14; B60K 37/00; B60R 21/20

(52) U.S. Cl. 280/728.3; 280/732; 180/90

(57) ABSTRACT

A dashboard for motor vehicles comprising a base part and an airbag cover which is integrated into the base part and which can be loaded by the inflating airbag. The surface formed by the base part and the airbag cover pointing towards the passenger space in the installed state being covered over by a masking. A structural element connects the airbag cover and base part to each other.

### TECHNICAL FIELD

The invention relates to a dashboard for motor vehicles.

### BACKGROUND OF THE INVENTION

In the manufacture of dashboards of this kind, points of view of both design and function are to be taken into account; and safety regulations which are in effect are to be observed as well.

### SUMMARY OF THE INVENTION

The problem (object) lying at the basis of the invention is to provide a dashboard which can be used in vehicles which are equipped with airbags and which has as low a weight as possible.

The solution of this problem takes place through the features of claim 1 and in particular in that a base part and an airbag cover which is integrated into the base part and which can be loaded by the inflating airbag are provided, with the surface which is formed by the base part and the airbag cover and which points towards the passenger space in the installed state being covered over by a masking.

Through the integration of the airbag cover into the base part the material thickness and the weight of the dashboard can be kept low. The masking permits the respective desired surface properties to be imparted to the surface of the base part which points towards the passenger space. Furthermore, the masking ensures that the contours of the airbag cover are not visible from the passenger space.

In accordance with a preferred embodiment of the invention the base part and the airbag cover are connected to one another at their reverse side by at least one structure element, with the structure element preferably having at least one support section which extends approximately parallel to the masking and beyond the transition between the base part and the airbag cover and with the structure element preferably being formed at least region-wise as a shot channel for an inflating airbag. In this the structure element fulfils two functions at the same time, since it both provides for the connection between the base part and the airbag cover and provides the shot channel which is necessary anyway in vehicles with an airbag.

In accordance with a further preferred exemplary embodiment of the invention the airbag cover is anchored, in particular is pivotally connected, to a structure element, preferably at a shot channel of the structure element. The airbag cover is preferably connected to a structure element via a hinge element which is preferably manufactured of nylon or metal. The airbag cover remains attached during airbag inflation through the structure element.

### BRIEF DESCRIPTION OF THE DRAWINGS

The present invention will now be described, by way of example, with reference to the accompanying drawings, in which:

FIGURE 1 is a part of a dashboard in accordance with the invention in a sectioned side view.

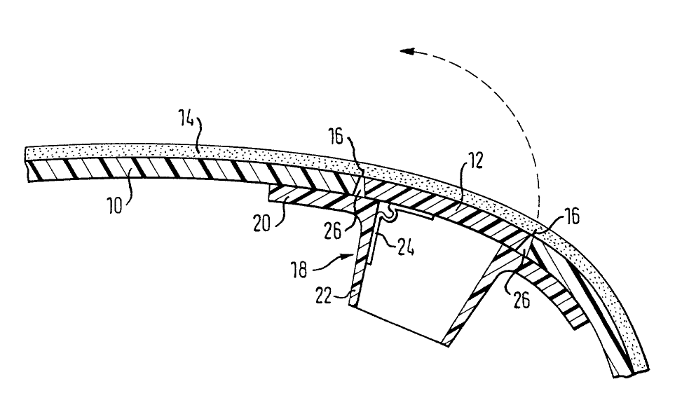

### DESCRIPTION OF THE PREFERRED EMBODIMENT

The dashboard in accordance with the invention which is illustrated in the figure comprises a base part 10 which is manufactured of a fibre material or of a plastic material which can be used in particular in the injection moulding process.

An airbag cover 12 is integrated into the base part 10 in such a manner that the base part 10 and the airbag cover 12 together form a continuous surface which points towards the passenger space—upwardly and to the right in the figure—in the installed state of the dashboard.

The airbag cover 12 consists of a material of particularly high strength which is different from the material which is used for the base part 10.

The surface which points towards the passenger space in the installed state and is formed in common by the base part 10 and the airbag cover 12 is covered by a masking 14 which is applied in the form of a laminate or of a plating, but which can also be molded from behind or pressed on from behind.

In the illustrated embodiment the dashboard in accordance with the invention is formed in a curved manner with a radius of curvature which increases in the direction towards the passenger space. The dashboard can have any shape desired, with the airbag cover being integrated into the base part 10 in the individual manner for the respective vehicle at the location required.

The edges of the base part 10 and the airbag cover 12 which face one another are chamfered in such a manner that open channels 26 with side walls which diverge from the masking 14 in approximately a V-shape result in the assembled state at the reverse side of the dashboard. The channels 26 enable the masking 14 to be provided with incisions 28 from the reverse side which are not visible from the passenger space in the state which is applied to the base part 10 and the airbag cover 12.

At their reverse side the base part 10 and the airbag cover 12 are connected to one another by a support section 20 of a structure element 18 which extend approximately parallel to the masking 14 and beyond the transition between the base part 10 and the airbag cover 12, i.e. beyond the channels 26.

Approximately perpendicular to the support section 20 of the structure element 18 there extends a frame-like shot channel section 22 which is formed in a single piece with the support section 20, which preferably has a square or rectangular cross-section in a plane extending approximately parallel to the masking 14 and which forms a shot channel for an inflating airbag in this manner.

The airbag cover 12 is anchored at the shot channel section 22 by means of a hinge element 24 which is preferably manufactured of nylon or metal and which is fastened at the shot channel section 22 and at the airbag cover 12. Instead of a hinge element of this kind other anchoring means can also be provided. Alternatively, the airbag cover 12 can also be formed in a single piece with the shot channel section 22 and be connected to the latter e.g. via a hinge region of reduced material thickness (living hinge).

When in the event of a collision the airbag is inflated, expands along the shot channel 22 which is formed by the shot channel section 22 of the structure element 18 and presses against the airbag cover 12, the masking 14 is torn open at the incisions 28 in the manner of desired breakage locations. The airbag cover 12 can then open and is pivoted upwards in the direction of the windshield of the vehicle as a result of its anchoring at the structure element 18 by means of the hinge element 24, with the end of the airbag cover 12 which is remote from the hinge element 24 moving along the path indicated by the arrows drawn in broken lines.

The airbag cover 12 is preferably made of a high strength material for handling the forces associated with airbag inflation. In addition, the base part 10 can be manufactured of a material of lower strength and thus of a more economical material since it must take up comparatively low forces and in addition is reinforced by the structure element 18.

A preferred material combination of the individual components of the dashboard in accordance with the invention preferably comprises materials which belong to a poly-propylene (PP) material family.

The following materials are preferably used:

base part (10): PP with slight admixtures of talcum and EPDM,

airbag cover (12): high strength injection moulding material of TPO

masking (14): foam back film of TPO

structure element (18): high strength injection moulding material of TPO.

What is claimed is:

1. A dashboard for a motor vehicle having an inflatable airbag and a passenger space, the dashboard comprising:
a base part;
an airbag cover connected to the base part and being loadable by the inflatable airbag; and
a masking continuously covering the base part and the air bag cover for presenting a continuous surface to the passenger space.

2. The dashboard in accordance with claim 1, characterised in that the base part and the airbag cover are manufactured of different materials, with the airbag cover being made of high strength and with the base part being an injection molded plastic material.

3. The dashboard in accordance with claim 1, characterised in that the masking is provided in the form of a laminate.

4. The dashboard in accordance with claim 1, characterised in that the masking is provided in the form a plating.

5. The dashboard in accordance with at claim 1, characterised in that the masking is incised in the region of a transition between the base part and the airbag cover, with the incisions preferably being provided at a reverse side of the masking and not being visible from the passenger space in the installed state.

6. The dashboard in accordance with claim 1, characterised in that the dashboard includes at least one structure element connecting the airbag cover and the base element to each other, the structure element having at least one support section extending parallel to the masking and beyond a transition between the base part and the airbag cover.

7. The dashboard in accordance with claim 6, characterised in that a structure element is formed at least region-wise as a shot channel for the inflatable airbag.

8. The dashboard in accordance with claim 6, characterised in that the structure element has at least one shot channel extending approximately perpendicular to the masking in the region of a transition between the base part and the airbag cover.

9. The dashboard in accordance with claim 6 characterised in that the support section and the shot channel of the structure element are integrally connected to one another and extend approximately at right angles to one another.

10. The dashboard in accordance with claim 6, characterised in that the airbag cover is pivotally connected to the structure element proximate the shot channel section of the structure element.

11. The dashboard in accordance with claim 6, characterised in that the airbag cover is connected to the structure element via a hinge element.
